(19) United States
(12) Patent Application Publication
(10) Pub. No.: US 2003/0214387 A1
(43) Pub. Date: Nov. 20, 2003

(54) Inventory & location system

(76) Inventor: Thomas Nello Giaccherini, Carmel Valley, CA (US)

Correspondence Address: Giaccherini, Post Office Box 1146, Carmel Valley, CA, 93924, US

(21) Appl. No.: 10/151,470

(22) Filed: May 20, 2002

(51) Int. Cl. G08B 13/14

(52) U.S. Cl. 340/10.1; 340/825.49; 340/572.1

(57) ABSTRACT

The present invention comprises methods and apparatus for locating items using passive transponders called radio frequency identification devices or “RFIDs.” In a first embodiment of the invention, a small business like a law firm or doctor's office can use self-adhesive RFID labels to keep track of files and important papers. In a second embodiment, items purchased from a retailer which are already attached to an RFID label are automatically detected and tracked by a wireless sniffer when the purchases are brought home. In a third embodiment, a retailer uses the RFID labels to conduct an automatic wireless inventory. In a fourth embodiment, the retailer uses the same system to reduce losses due to theft of merchandise. In a fifth embodiment, the retailer uses the RFID labels to provide automatic wireless check-out. In a sixth embodiment, the retailer analyzes the inventory of goods within a customer's home to enhance sales and marketing strategies. In a seventh embodiment, the retailer uses the home inventory data to furnish automatic order fulfillment. In an eighth embodiment, the customer uses the portable sniffer to retrieve information about a product stored in an RFID.

### FEDERALLY SPONSORED RESEARCH OR DEVELOPMENT

None.

### FIELD OF THE INVENTION

The present invention pertains to methods and apparatus for inventory management, asset tracking and building marketing databases. More particularly, one preferred embodiment of the invention employs wireless, passive radio frequency identification “RFID” devices and software to provide a novel business or household inventory management system.

### BACKGROUND OF THE INVENTION

The business of managing and tracking assets and goods using passive, wireless radio frequency identification device (RFID) equipment is just beginning to find application in commercial markets. In general, an RFID is a passive device which emits a response when it is in the presence of an electromagnetic field. These generally small, thin, planar devices may be configured so that each RFID will emit a unique response when illuminated with a particular radio frequency signal. Over the past few decades, RFIDs have been used in combination with labels pasted to the inside covers of books to control the flow of library books. Many items sold by retailers, including articles of clothing and digital recordings like CDs and DVDs are protected with RFIDs that are stuck onto packaging that enclose the recordings.

While RFIDs have been proposed for use in some warehouse or institutional settings to track various items, they generally have not been employed as part of a widely deployed business or household inventory management system. The development of such a system would constitute a major technological advance, and would satisfy long felt needs and aspirations in the inventory control and asset location industries.

### SUMMARY OF THE INVENTION

The present invention comprises methods and apparatus for locating items using passive transponders called radio frequency identification devices or “RFIDs.” In a first embodiment of the invention, a small business like a law firm or doctor's office can use self-adhesive RFID labels to keep track of files and important papers. In a second embodiment, items purchased from a retailer which are already attached to an RFID label are automatically detected and tracked by a wireless sniffer when the purchases are brought home. In a third embodiment, a retailer uses the RFID labels to conduct an automatic wireless inventory. In a fourth embodiment, the retailer uses the same system to reduce losses due to theft of merchandise. In a fifth embodiment, the retailer uses the RFID labels to provide automatic wireless check-out. In a sixth embodiment, the retailer analyzes the inventory of goods within a customer's home to enhance sales and marketing strategies. In a seventh embodiment, the retailer uses the home inventory data to furnish automatic order fulfillment. In an eighth embodiment, the customer uses the portable sniffer to retrieve information about a product stored in an RFID.

An appreciation of the other aims and objectives of the present invention and a more complete and comprehensive understanding of this invention may be obtained by studying the following description of a preferred embodiment, and by referring to the accompanying drawings.

### A BRIEF DESCRIPTION OF THE DRAWINGS

FIG. 1 supplies views of an RFID.

FIG. 2 exhibits how an RFID functions like a transponder, emitting a response when stimulated or illuminated by an interrogation signal.

FIG. 2A reveals internal circuit details of a sniffer.

FIG. 3 shows a customer purchasing a roll of RFID labels.

FIG. 4 shows the customer applying an RFID label to a file. Each RFID label is has its own unique “serial number,” and is configured to emit a distinctive, identifiable response when stimulated by an interrogation signal.

FIG. 5 depicts the file being brought within the active range of an RFID label “sniffer,” which is connected to a personal computer.

FIG. 6 illustrates the screen of the personal computer conveying a prompt for the customer to supply a file identification number that will be assigned to the RFID label that has been applied to the file that was just detected.

FIG. 7 reveals the same computer screen, which now displays a confirmation of the assignment of a file identification number to the detected RFID file label.

FIG. 8 depicts the customer using the software database which contains the RFID serial numbers and their associated file identification numbers. The customer has entered the identification for the file he now wants to find.

FIG. 9 portrays the customer as he picks up the portable “sniffer” from its desktop cradle. The database software has instructed the sniffer to search for a particular file.

FIG. 10 shows the customer hunting for the lost file with the portable sniffer, which begins to beep louder and louder is it approaches the lost file.

FIG. 11 shows the customer as he finds the missing file.

FIG. 12 shows a customer purchasing a Skil® Saw at a big hardware store. An RFID label is already attached to the box.

FIG. 13 depicts the customer as he enters the front door of this home, carrying the new Skil® Saw. A wireless sniffer positioned on the floor near the front door detects the RFID label attached to the outside of the Skil® Saw, and reports the new purchase to the customer's personal computer.

FIG. 14 reveals the display at the personal computer which has just updated the software database wirelessly and automatically as a result of the customer bringing the new purchase into the home.

FIG. 15 depicts the method of automatic wireless inventory management. Every item on the shelf in the Great Big Hardware Store is attached to an RFID label. Each RFID is configured to respond to a single inventory signal emitted by a sniffer mounted on the ceiling of the store. Particular items may be located by causing the sniffer to emit an interrogation signal which causes each RFID to emit a unique response.

FIG. 16 depicts the method of loss mitigation. A thief who has shoplifted merchandise bearing an RFID label has been stopped by a wireless sniffer mounted above the exit of a retailer.

FIG. 17 depicts the method of wireless automatic check-out. Neither the customer nor the sales clerk need remove the items from the shopping cart. All the RFID labels in the cart are detected by a sniffer mounted overhead, and the sales total is reported to the cash register wirelessly and automatically.

FIG. 17A provides a view of tallying inbound shipments at a loading dock.

FIG. 18 depicts the method of automatic home inventory data mining. All the items in the customer's house are attached to RFID labels, which are automatically detected by a sniffer or sniffers placed inside the house. A personal computer inside the house keeps track of the inventory of items in the house, and periodically reports the inventory automatically to the retailer via a modem using a conventional telephone line. The retailer and/or his suppliers use this information to analyze their sales and marketing strategies.

FIG. 19 depicts the method of automatic order fulfillment. Once the retailer has received home inventory data, he can supply the customer with periodic or specific shipments of items whose stock has run low at the customer's house. The retailer may arrange to have a supplier ship these goods directly to the consumer.

FIG. 20 depicts the method of customer support information. A customer uses a portable sniffer to retrieve a model number, purchase and manufacturing information and phone numbers for technical support, warranty claims and repair information that are stored in the RFID label attached to the television set.

### A DETAILED DESCRIPTION OF PREFERRED & ALTERNATIVE EMBODIMENTS

1. Overview of the Invention

The present invention comprises methods and apparatus for locating items using passive transponders called radio frequency identification devices or “RFIDs.” In a first embodiment of the invention, a small business like a law firm or doctor's office can use self-adhesive RFID labels to keep track of files and important papers. In a second embodiment, items purchased from a retailer which are already attached to an RFID label are automatically detected and tracked by a wireless sniffer when the purchases are brought home. In a third embodiment, a retailer uses the RFID labels to conduct an automatic wireless inventory. In a fourth embodiment, the retailer uses the same system to reduce losses due to theft of merchandise. In a fifth embodiment, the retailer uses the RFID labels to provide automatic wireless check-out. In a sixth embodiment, the retailer analyzes the inventory of goods within a customer's home to enhance sales and marketing strategies. In a seventh embodiment, the retailer uses the home inventory data to furnish automatic order fulfillment. In an eighth embodiment, the customer uses the portable sniffer to retrieve information about a product stored in an RFID.

2. Preferred & Alternative Embodiments of the Invention

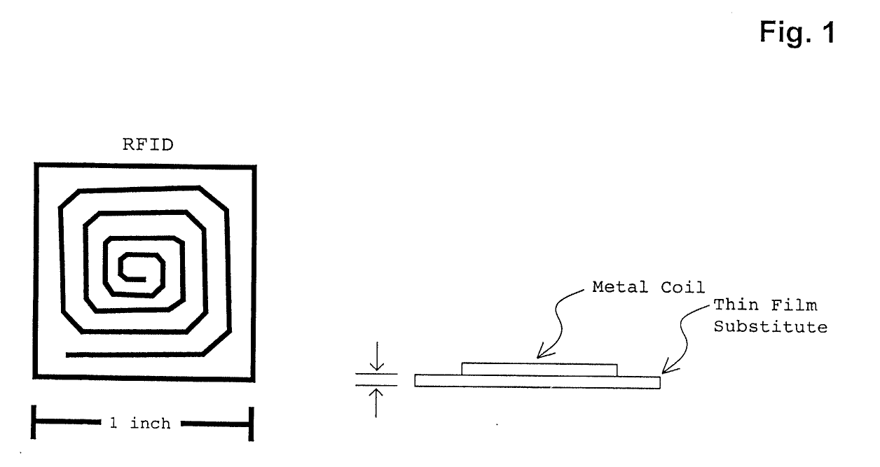

In general, an RFID is a relatively small, thin, planar device comprising a substrate and a conductor as depicted schematically in FIG. 1. The conductor may be configured as a spiral, some other different continuous pattern, or a set of separate conductors. The design of the conductor is generally based on the response signal which the RFID will emanate when stimulated. In general, each RFID is characterized by a unique serial number which may be associated with other information using a software database. In an alternative embodiment of the invention, an RFID pattern may be printed or applied directly on the surface of a package using a generally conductive ink. An RFID may also be incorporated directly into the surface or body of a product during the manufacturing process.

Passive RFIDs do not require a power source like a battery. The preferred embodiment of the invention generally utilizes passive RFIDs, although some situations may call for the use of an active, powered RFID. Generally planar, limited-life batteries may be incorporated into the RFID during the manufacturing process.

In general, RFIDs are transponders which emit a response signal when they are stimulated or illuminated by an external signal. Although the preferred embodiment of the invention employs transponder devices which operate in the radio frequency bands, other transponders that may employ acoustic, ultrasonic, infrared or other optical signals or any other kind of sensible response may be utilized to practice the invention. In the simplest terms, an RFID takes some of the energy of an external signal, and converts it to a particular emanation or reflection that can be sensed by a detector. In this Specification and in the Claims that follow, this detector is usually called a “sniffer.” This sniffer is usually automatic, and may be wired or wireless. The sniffer may be powered by batteries, or may require a standard cable and plug for a 110VAC electrical outlet. In one embodiment of the invention, the sniffer communicates wirelessly with a personal computer. In this Specification and in the Claims that follow, the terms “RFID” or “transponder” generally comprise any device, apparatus, method or means, whether passive or active, which enables a first signal, wave or field to be varied, reflected, returned, emitted, emanated or propagated in a way that enables the remote detection, sensing or identification of a particular item. Each RFID may be manufactured with a slightly different conductor pattern, so that each uniquely configured RFID in a set of many RFIDs will return a unique signal when they each encounter the external signal. The invention may also utilize RFIDs that are configured so that they all simultaneously respond to a single “all-hands” or “inventory” signal.

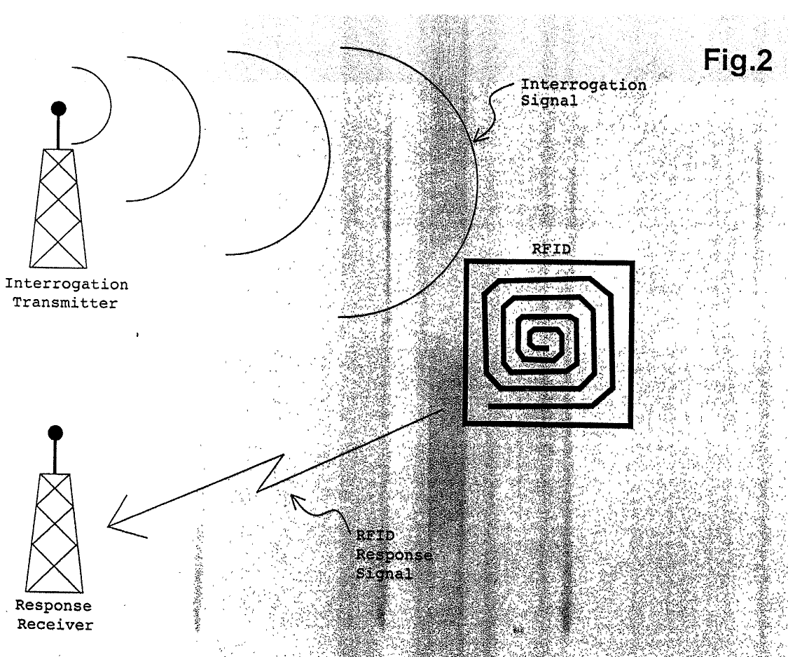

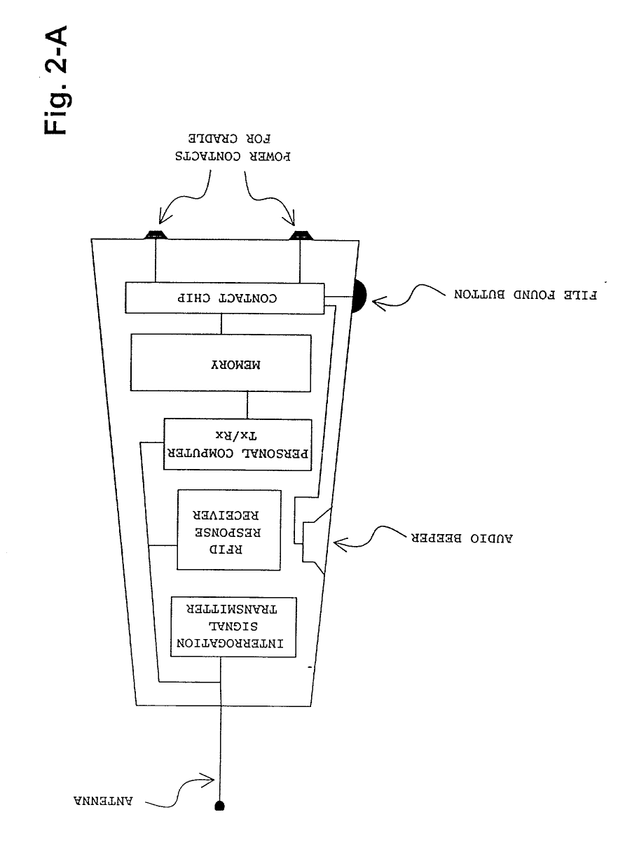

In a preferred embodiment of the invention, a sniffer is a wireless device which emits a generally continuous “interrogation” radio frequency signal. The effective range of the sniffer may be a few feet, or may encompass a large range to incorporate a single room, an entire house, or a very large retail store. The area of operation of the sniffer comprises an interrogation zone. As shown in FIG. 2, a sniffer generally includes a transmitter that is capable of emitting this interrogation signal. When each RFID within the operating range of the sniffer emits its unique response, the sniffer detects all of these responses. In the preferred embodiment of the invention, the sniffer is also capable of communicating wirelessly with a personal computer. The personal computer is loaded with database software which associates the unique RFID serial number with identifying information about the object or item which is attached to a particular RFID label. Based on instructions from the computer user, the database software can instruct the sniffer to listen only for one particular response signal, which enables the user to find a particular item using the sniffer.

FIG. 2A is a schematic diagram showing the generalized circuit details of one embodiment of a sniffer. An external antenna is coupled to circuit stages which generate an interrogation signal, receive RFID response signals, and communicate with a personal computer. In alternative embodiments, the sniffer may communicate with other devices, such as personal digital assistants, televisions, telephones or kitchen appliances such as refrigerators. Other sections of the sniffer's internal circuitry may include a control chip, a memory, a rechargeable battery, and an audio beeper. In one embodiment, the sniffer is powered by a battery which receives power through contacts that mate with similar contacts on the sniffer's desktop cradle.

3. First Embodiment: Finding Files in an Office

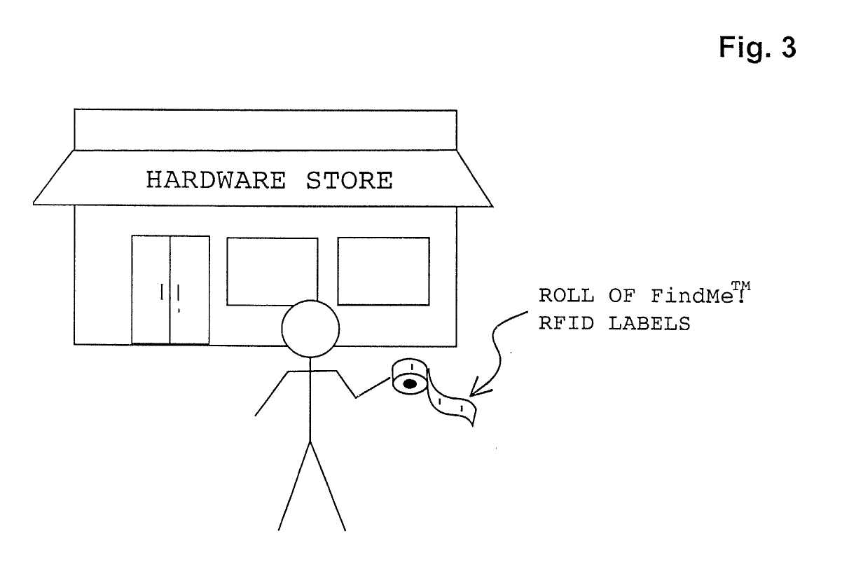

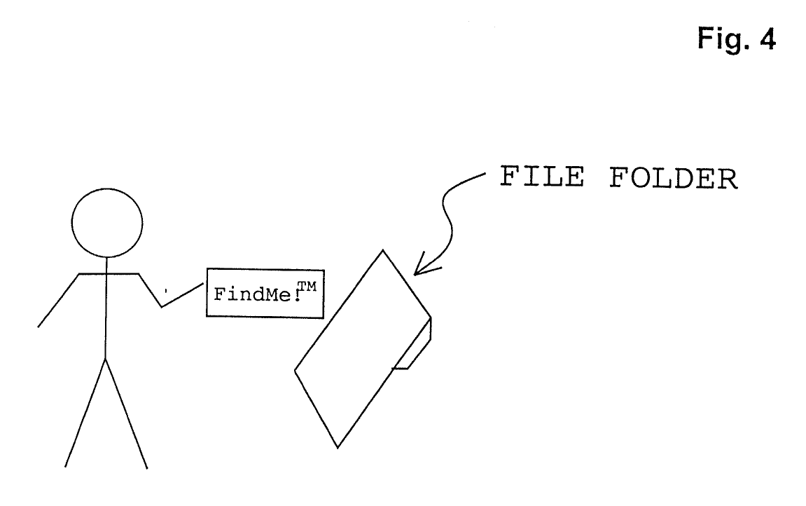

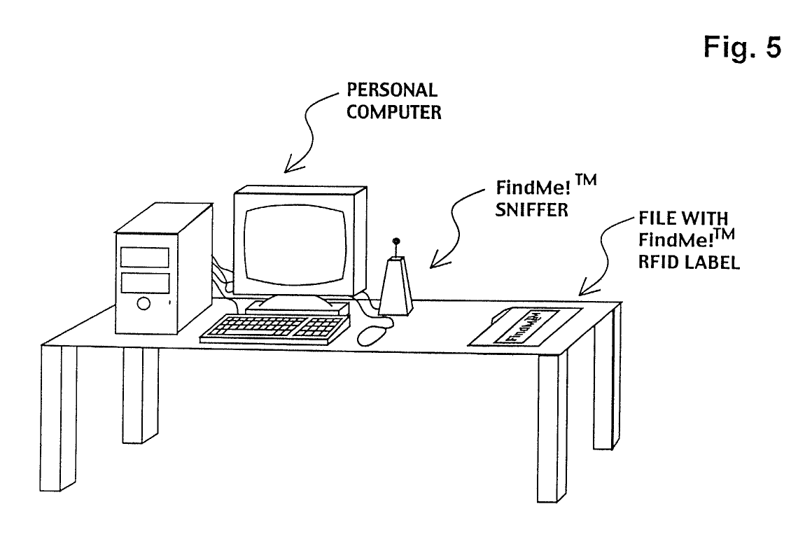

In a first embodiment of the invention, a small business like a law firm or doctor's office can use self-adhesive RFID labels to keep track of files, papers, equipment or other objects. As shown in FIG. 3, a customer purchases a roll of self-adhesive RFID labels at a hardware store. In an alternative embodiment of the invention, the customer can use RFID label software to print his own labels using a printer that employs conductive ink. FIG. 4 shows the customer applying an RFID label to a file or other object that he wishes to track. FIG. 5 depicts a table in the customer's office. A personal computer on the floor under the table is attached by a USB cable to a sniffer cradle that holds and powers a sniffer. In an alternative embodiment, the connection between the personal computer and the sniffer may be a wireless connection that uses WiFi (802.11b), Bluetooth, or a 900 MHz band transceiver, or some other wireless communication means. The customer has installed database software on the personal computer which associates a set of RFID serial numbers to information supplied and input by the customer.

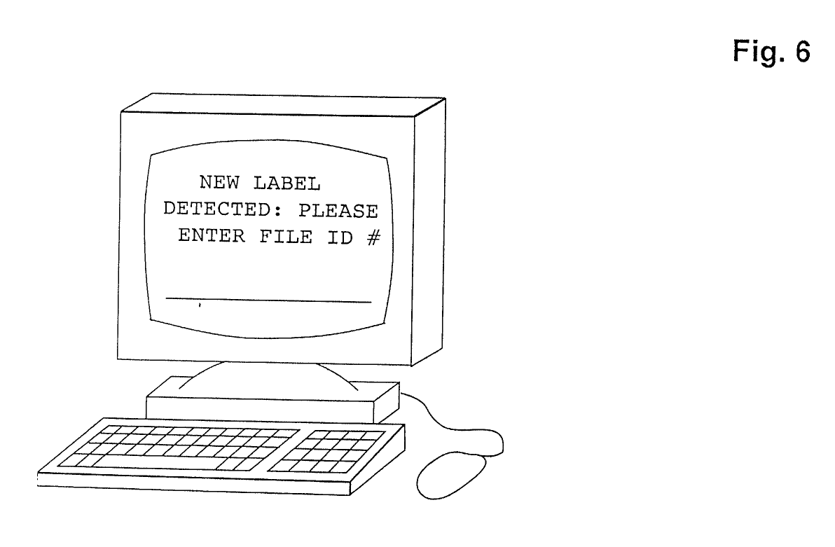

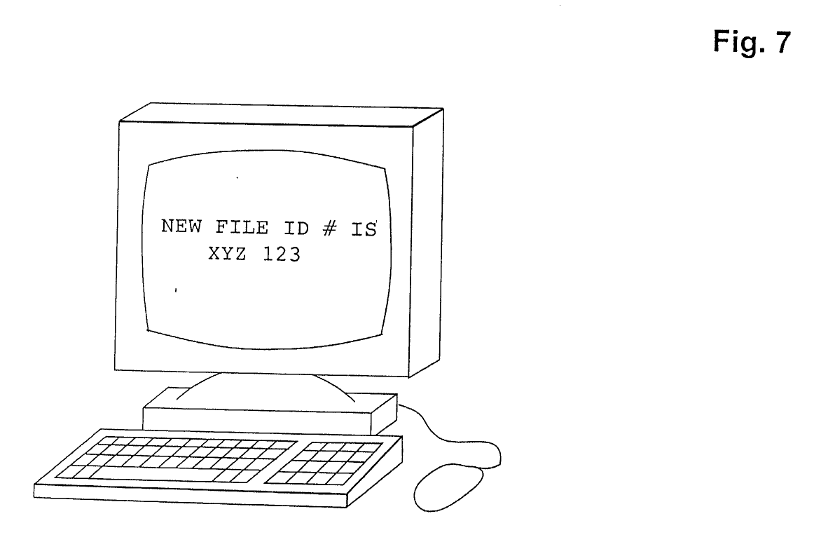

When the file bearing the RFID label is brought within the operating range of the desktop sniffer for the first time, the sniffer detects the new label, and reports its presence to the database software. FIG. 6 shows the screen of the personal computer, which now displays a prompt for the user to enter some identifying information about the object to which he has just attached an RFID label. Since the object in this case is a file containing important papers, the software requests the user to enter a “file identification number.” As shown in FIG. 7, the user responds to the prompt by entering file ID number “XYZ123.” The software then automatically associates this FID with the serial number on the RFID to which it is attached. Once this association is stored in the database, the software determines that this particular RFID label is no longer new. After this event occurs, a response signal from the RFID that is detected by the sniffer will generally be ignored, so that the software no longer identifies this RFID as a “new” RFID which requires user intervention and identification.

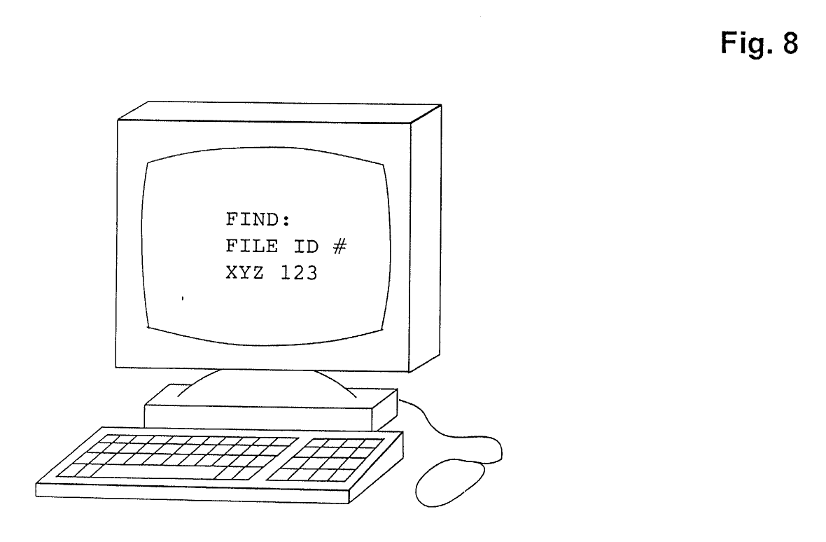

At some time in the future, the customer has lost or misplaced file XYZ123. He then turns to the database software for assistance. FIG. 8 shows the customer entering a query, which requests the database software to find the RFID serial number that is uniquely associated with file XYZ123. The software quickly retrieves the serial number, which has been stored in a file on the personal computer's hard drive, and issues instructions to the sniffer. These instructions tell the sniffer to emit an “interrogation signal” that will stimulate a response from all the RFIDs within the operating range of the sniffer. Most importantly, the sniffer is instructed to “listen for” only the response of the RFID that is attached to file XYZ123. All other responses are then ignored until the missing file is found.

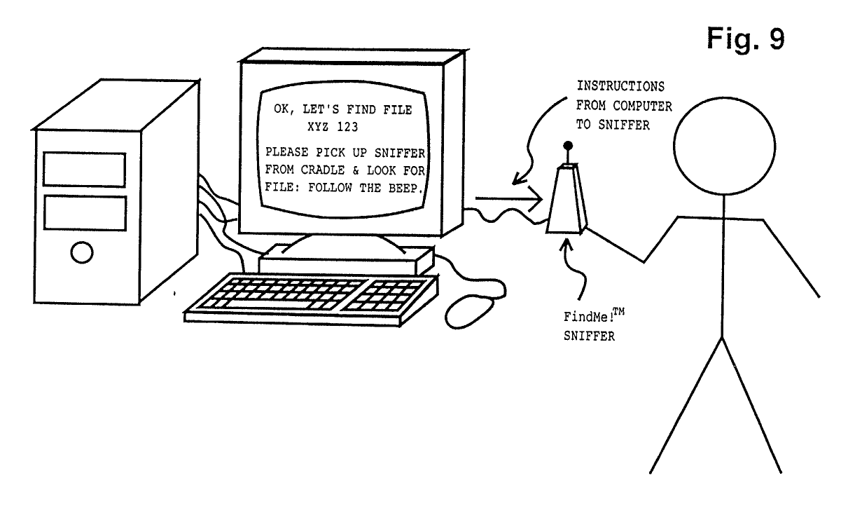

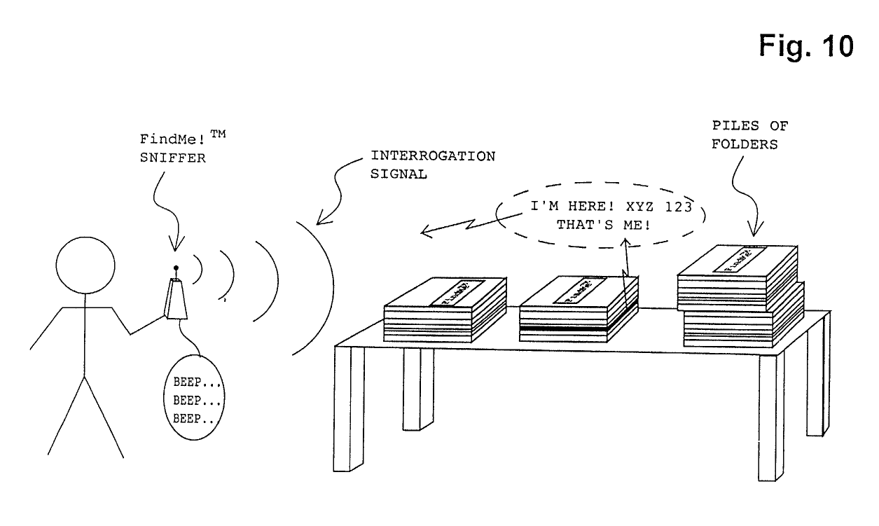

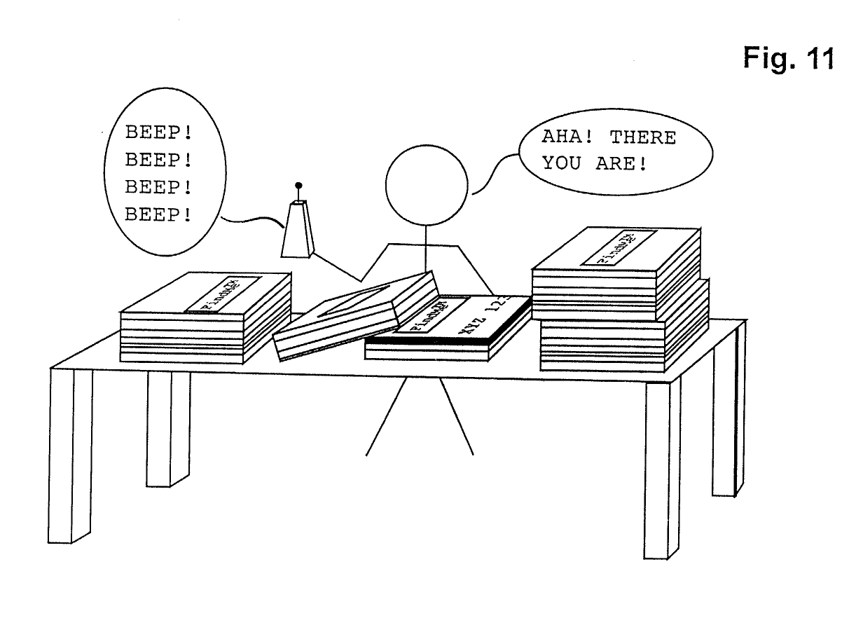

As shown in FIG. 9, the software displays a message which prompts the user to pick the portable sniffer up out of its desk top cradle. The sniffer then begins to emit its interrogation signal. The user then walks around the office holding the sniffer. When the response from the missing file is detected, the sniffer begins to emit an audible beep. FIG. 10 depicts the user as he “homes in” on the missing file. As he does so, the beeping becomes louder, leading the user toward the wayward file. In an alternative embodiment of the invention, small repeaters may be placed in metal file cabinets to assist this process. These repeaters, which comprise an external antenna and an internal radiator, illuminate files stored in a file cabinet which may impede the penetration of an external interrogation signal. FIG. 11 shows the user as he finds the lost file in a stack on another table in the office. Once the file is found, the user can press a button on the sniffer or enter a command at the computer to indicate that the locating process has been successfully completed. This method is not limited to files, but may also be utilized to find objects like staplers, scissors, discs, diaries, separate pieces of paper or virtually any other object that may be attached to an RFID label.

4. Second Embodiment: Finding Items at Home

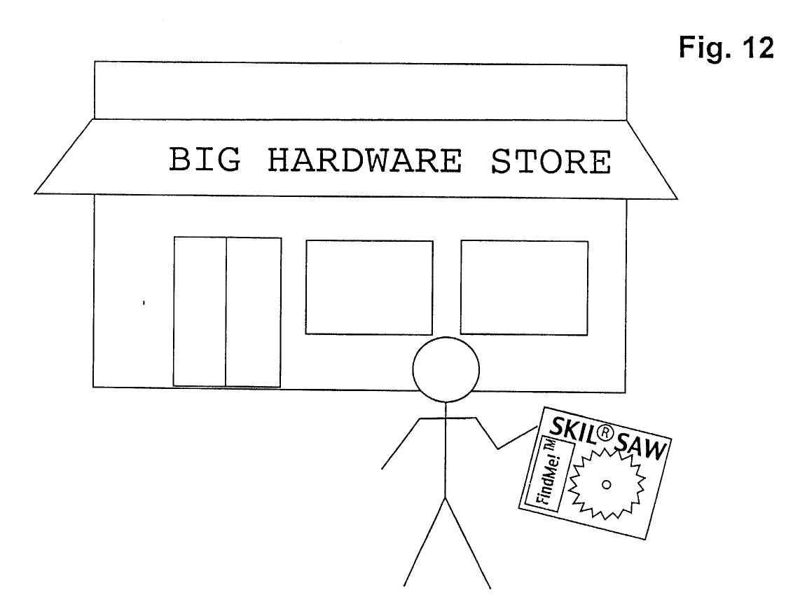

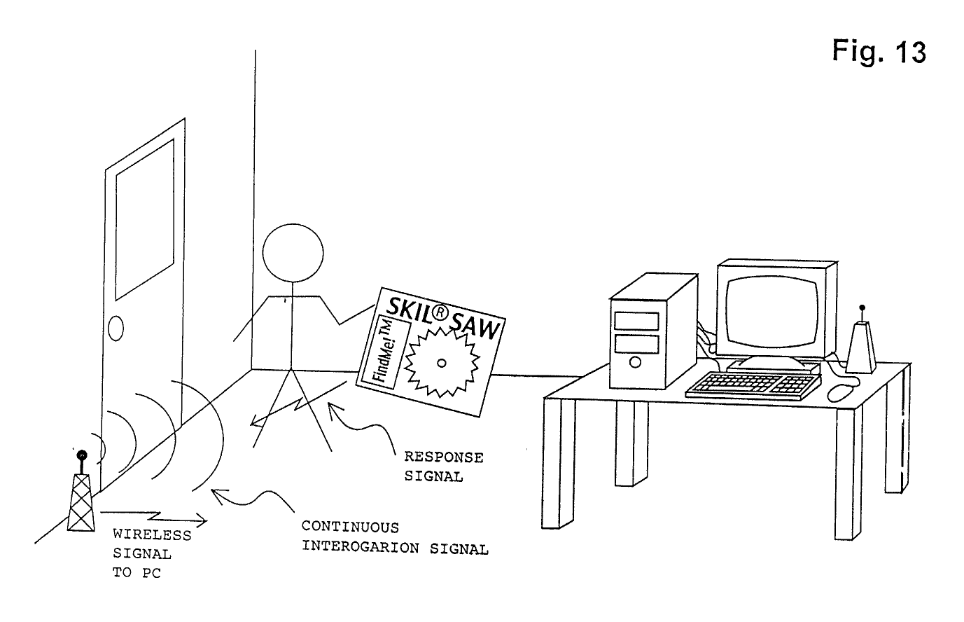

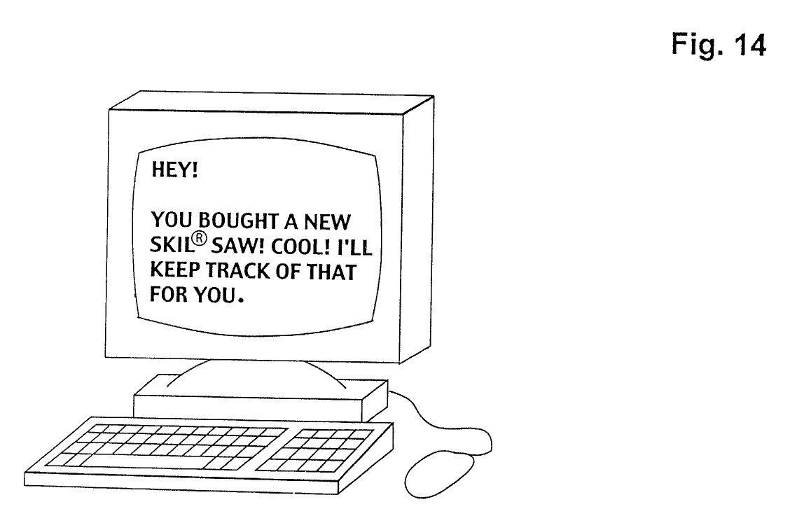

In a second embodiment, items purchased from a retailer which are already attached to an RFID label are automatically detected and tracked by a wireless sniffer when the purchases are brought home. FIG. 12 portrays a customer as he leaves a Big Hardware Store, carrying his new purchase, a Ski® Saw. FIG. 13 shows the customer entering the front door to his home. The manufacturer or the retailer has already placed or printed an RFID on the box which encloses the saw. As the customer enters the door to his residence, a sniffer placed on the floor near the doorway detects the new purchase. In a preferred embodiment, this wireless sniffer automatically and continuously emits an interrogation signal that searches for an RFID label which it has never seen before. The user's house may contain many sniffers, which all communicate wirelessly with a personal computer. A sniffer could even be installed in the user's car. This mobile sniffer would be able to report new purchases as the car enters the driveway or garage. In each case, the first job of these “front-door” sniffers is to detect new RFID labels once and once only. As described above in Section 3, the database software running on the customer's personal computer makes an entry in a database as soon as a new RFID, which has a new unique serial number that has never been sensed previously, has been detected for the first time. FIG. 14 exhibits a message displayed by the personal computer, which indicates that the new purchase has been automatically logged without any user intervention. This automatic recordation is made possible by the fact that the RFID on the Skil® Saw box contains information about the new saw. This information is reported automatically to the computer. Just as printed barcodes each convey particular information about items or packaging, the present invention allows RFIDs to be used to automatically identify new additions to a household inventory. The invention also enables the composition of a master library of RFID “words” and data, which are uniquely defined and universally utilized to represent fields of information.

In an alternative embodiment of the invention, the “front door” sniffer can be configured to sense RFIDs as they pass out of the house. The location method may be enhanced if each room or closet in the house has its own sniffer.

5. Third Embodiment: Automatic Wireless Inventory

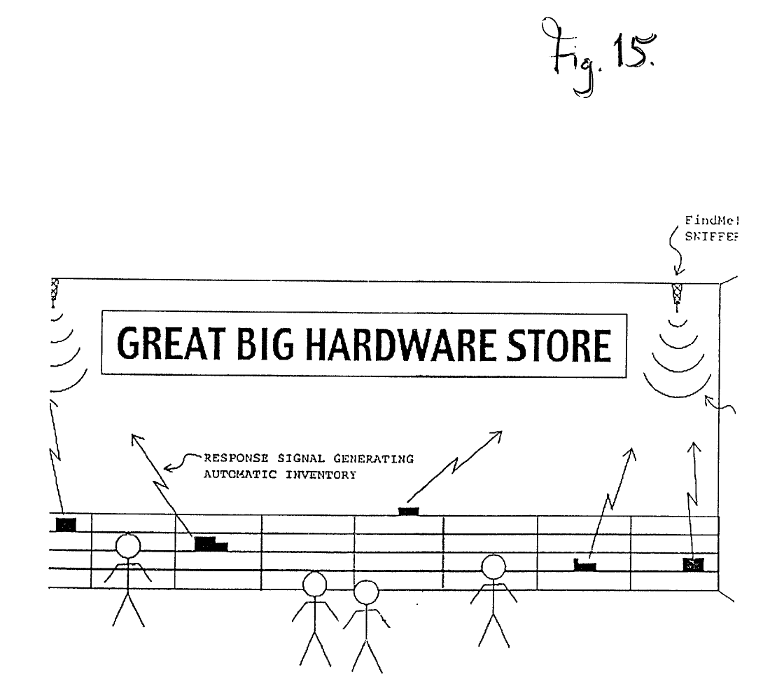

In a third embodiment, a retailer uses the RFID labels to conduct an automatic wireless inventory. FIG. 15 provides a general view of the inside of the Great Big Hardware Store. A sniffer is mounted on the ceiling. Every item of stock inside the store has an RFID label attached. When the sniffer is activated and emits an interrogation signal, every RFID responds by issuing a return signal. The sniffer is coupled to a local computer, or perhaps to a central, remote computer at corporate headquarters. This method enables automatic, continuous inventory without the enormous labor cost of a manual inventory. This embodiment of the invention is applicable to any retailer, warehouse, storeroom, factory, library or any other site or environment where many items need to be tracked or located.

6. Fourth Embodiment: Loss Mitigation

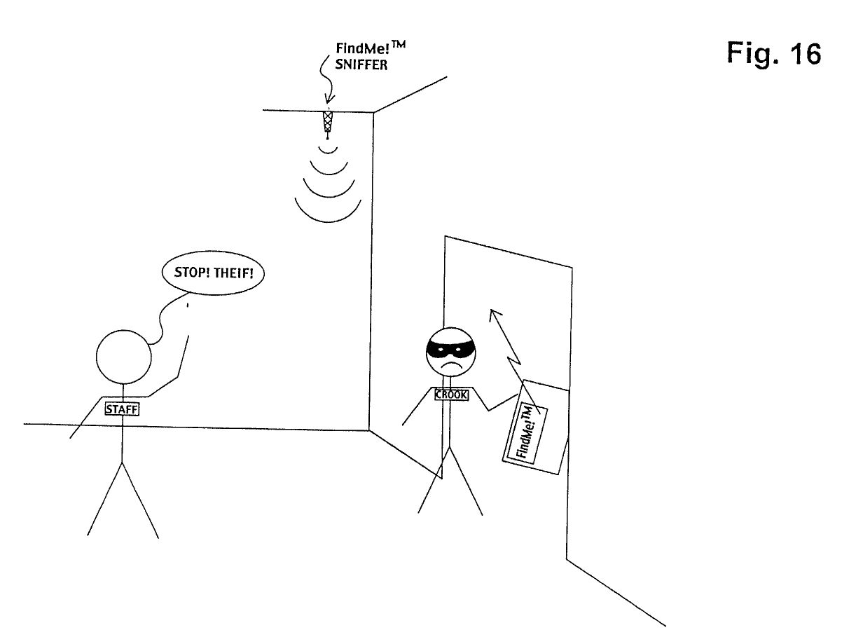

In a fourth embodiment, the retailer uses the same system to reduce losses due to theft of merchandise. FIG. 16 shows a sniffer mounted over a door at the same retailer. Any time an article of merchandise attached to an RFID label approaches an exit without having first been purchased, an alarm is activated. A computer running database software is able to keep track of which items leaving the store have been paid for, and of those which have been pilfered. This method provides loss mitigation by reducing shoplifting or theft by employees or vendors. This method may be improved by using RFIDs which have been embedded in the body or surface of the merchandise, rather than simply placing RFIDs on boxes or packaging. As an example, the Skil® Saw described in Section 3 may be manufactured with its RFID embedded in its body or handle.

7. Fifth Embodiment: Automatic Wireless Check-Out

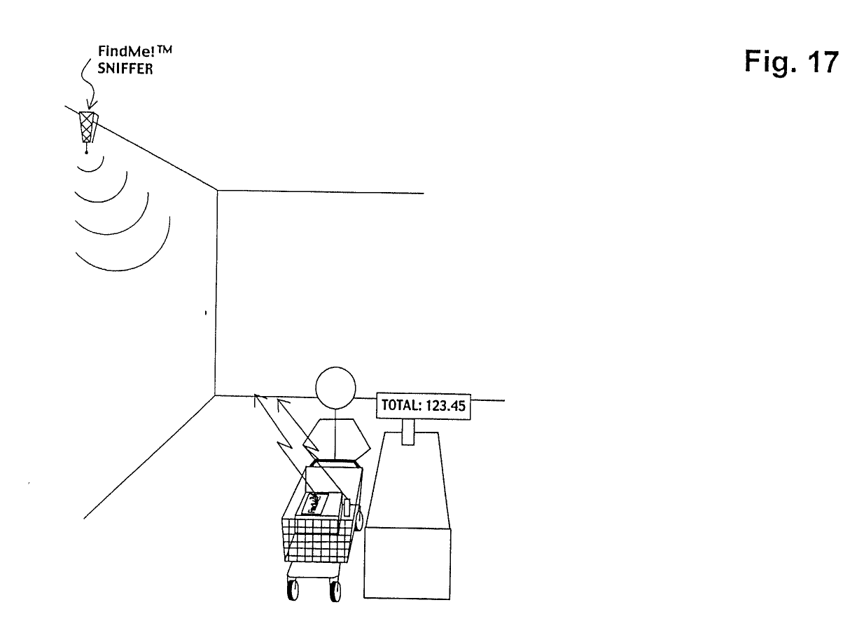

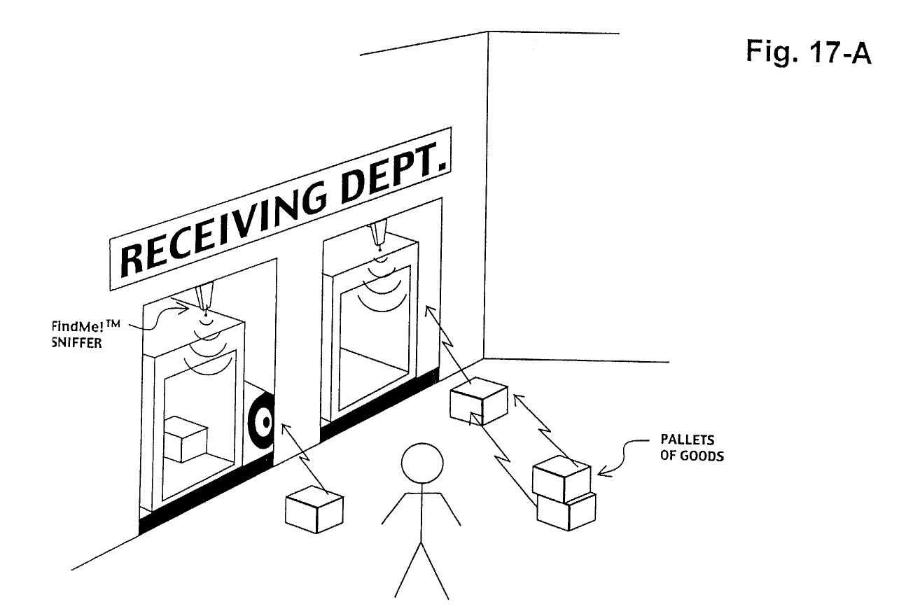

In a fifth embodiment, the retailer uses the RFID labels to provide automatic wireless check-out. FIG. 17 depicts a shopper who is ready to ring up the items in her shopping cart at the check-out counter in the Great Big Hardware Store. Every item in the cart has an RFID attached to it. A sniffer mounted overhead is capable of detecting only the items in the shopping cart below it. The sniffer wirelessly totals the purchases, and reports the sales data to the cash register. This method may also be employed at the loading dock in the back of the store to track goods as they are delivered to the retailer. In that variation of this embodiment, sniffers mounted over loading bay doors tally the arrival of goods from suppliers wirelessly and automatically. FIG. 17A depicts another alternative embodiment, which could be used to tally inbound shipments in the Receiving Department of the store.

8. Sixth Embodiment: Automatic Home Inventory

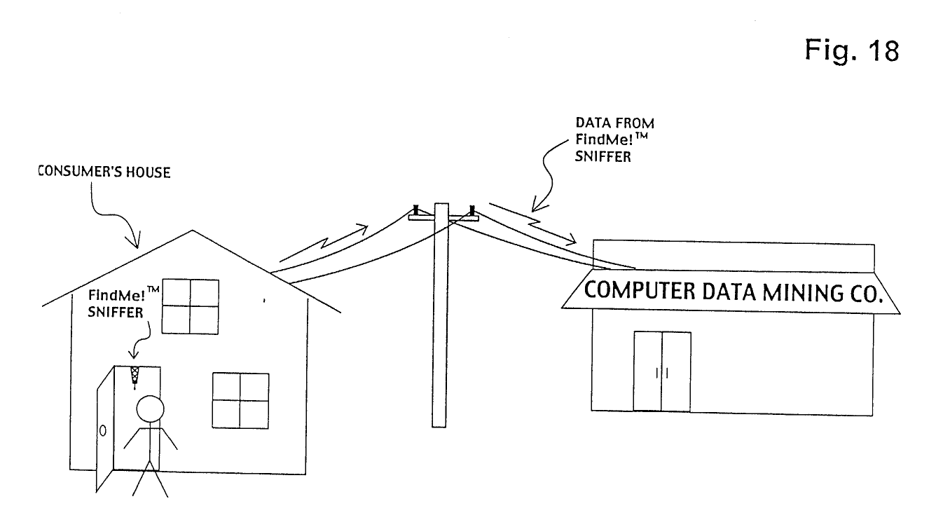

In a sixth embodiment, the retailer analyzes the inventory of goods within a customer's home to enhance sales and marketing strategies. FIG. 18 depicts a consumer's house. The consumer has purchased items at Big Co., a retailer whose merchandise bears RFIDs. When the consumer brings these items home, sniffers inside the house automatically report the purchases to the personal computer inside the house. In this embodiment of the invention, automatic reporting software has been installed on the personal computer. This software automatically compiles a household inventory of all the purchased items in the consumer's home, and reports the inventory to a central computer at Big Co. using a modem and a conventional telephone line. Large computers at Big Co.'s computer center analyze the inventories reported from the homes of many consumers. All this data is analyzed to improve Big Co.'s sales and marketing methods. The data reported to Big Co. enables the retailer to better understand brand affinities, purchasing habits and sales demographics. This data maybe shared with or sold to Big Co.'s suppliers. Big Co. may offer a discount on purchases at its stores for consumers who agree to participate in this home inventory reporting.

9. Seventh Embodiment: Automatic Order Fulfillment

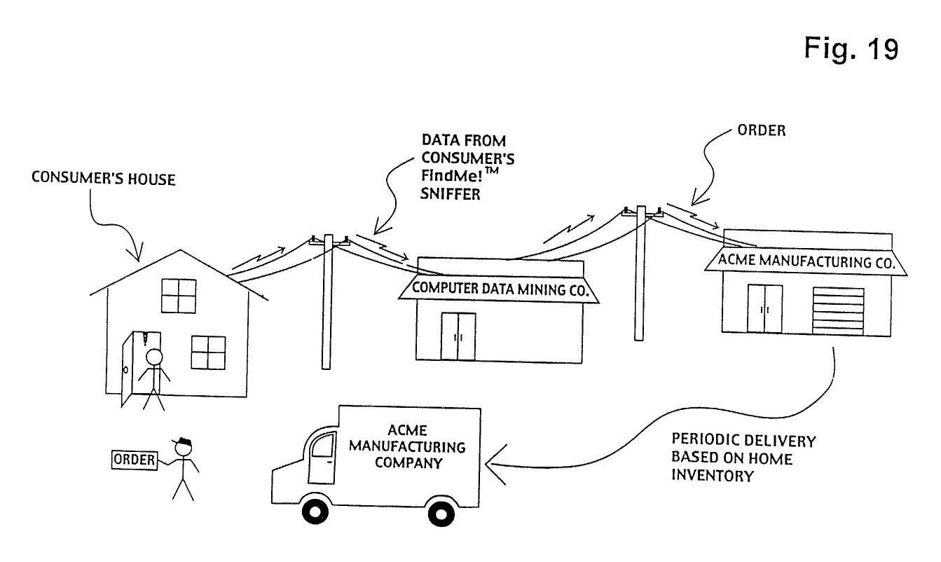

In a seventh embodiment, the retailer uses the home inventory data described in Section 8 to furnish automatic order fulfillment. Once Big Co. has received home inventory data for specific houses, it is able to automatically fill orders to restock household items that are in short supply. The customer can create a standing order that is filled periodically, or deliveries may be dispatched when supplies run low. The orders may be filled directly by Big Co.'s suppliers as shown in FIG. 19, who can ship the goods to the consumer's home using couriers like UPS® or Federal Express.® This method of the invention enables the retailer to generate additional sales without incurring the overhead costs normally associated with stocking the store shelf with merchandise.

10. Eighth Embodiment: Retrieving Product Information

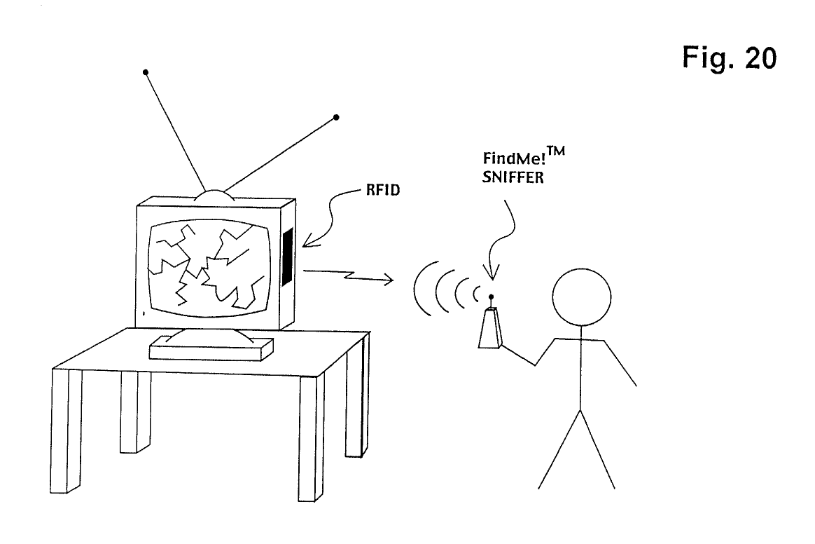

In an eighth embodiment, the customer uses the portable sniffer to retrieve information about a product stored in an RFID. FIG. 20 shows a customer using a sniffer to retrieve information from an RFID attached to a television. The RFID may be programmed to store information about the television set, including the model number, manufacturing date, serial number and purchase information. The RFID can also store phone numbers that the customer can use to obtain warranty or repair service or to obtain technical support.

Conclusion

Although the present invention has been described in detail with reference to one or more preferred embodiments, persons possessing ordinary skill in the art to which this invention pertains will appreciate that various modifications and enhancements maybe made without departing from the spirit and scope of the claims that follow. The various alternatives that have been disclosed above are intended to educate the reader about preferred embodiments of the invention, and are not intended to constrain the limits of the invention or the scope of claims.

What is claimed is:

1. A method comprising the steps of:
using a wireless sniffer to produce an interrogation signal in a detection zone; said wireless sniffer also for communicating with a personal computer running database software on a personal computer to track objects in said detection zone;
introducing a passive wireless transponder means for responding to an interrogation signal into said detection zone; said passive wireless transponder means being connected to an object;
using said wireless sniffer to receive a return signal generated by said passive wireless transponder means in-response to said interrogation signal; and
recording the presence of said passive wireless transponder means in said detection zone.

2. A method as recited in claim 1, in which said passive wireless transponder means is a radio frequency identification device.

3. A method as recited in claim 2, in which said radio frequency identification device stores unique identifying information.

4. A method comprising the steps of:
manually applying said passive wireless transponder means to an object; and
finding said object using a audible signal generated by a portable wireless sniffer which has received location instructions from said personal computer running database software that tracks said objects.

5. A method as recited in claim 4, in which said object is a file in an office.

6. A method as recited in claim 4, in which said object is a household item.

7. A method as recited in claim 1, in which said interrogation signal is a wireless sniffer which communicates with said database software running on said personal computer which communicates with a remote computer, which enables home automated inventory.

8. A method as claimed in claim 1, in which a plurality of said return signals is compiled to produce an automatic wireless inventory.

9. A method as claimed in claim 1 comprising the additional steps of:
using said wireless sniffer to detect the departure of an object from said detection zone; and
communicating said departure of said object to said database software running on said personal computer, which communicates with a remote computer, to enable automatic order fulfillment.

10. A method as claimed in claim 9, in which a retailer detects said departure of said object to generate an alert to reduce losses due to theft of merchandise.

11. A method as claimed in claim 10, in which a retailer detects said departure of said object to generate a sales total to enable automatic check-out.

12. A method as claimed in claim 9, in which a retailer detects said departure of said object to generate a sales total to enable automatic check-out.

13. A method as claimed in claim 9, in which a retailer detects an arrival of an object to enable automatic receiving tallies of shipped goods.

14. A method as claimed in claim 9, in which said portable sniffer is used to retrieve information about a product stored in said passive wireless transponder means.
